(19) United States
(12) Patent Application Publication
(10) Pub. No.: US 2021/0406364 A1
(43) Pub. Date: Dec. 30, 2021

(54) SYSTEM FOR DUAL-FILTERING FOR LEARNING SYSTEMS TO PREVENT ADVERSARIAL ATTACKS

(71) Applicants: DIPANKAR DASGUPTA, GERMANTOWN, TN (US); KISHOR DATTA GUPTA, MEMPHIS, TN (US)

(72) Inventors: DIPANKAR DASGUPTA, GERMANTOWN, TN (US); KISHOR DATTA GUPTA, MEMPHIS, TN (US)

(21) Appl. No.: 17/316,009

(22) Filed: May 10, 2021

Related U.S. Application Data
(60) Provisional application No. 63/022,323, filed on May 8, 2020.
(60) Provisional application No. 63/186,088, filed on May 8, 2021.

(51) Int. Cl. G06F 21/55; G06N 3/12

(52) U.S. Cl. CPC G06F 21/55; G06F 2221/034; G06N 3/126

(57) ABSTRACT

A Dual-Filtering (DF) system to provide a robust Machine Learning (ML) platform against adversarial attacks. It employs different filtering mechanisms (one at the input and the other at the output/decision end of the learning system) to thwart adversarial attacks. The developed dual-filter software can be used as a wrapper to any existing ML-based decision support system to prevent a wide variety of adversarial evasion attacks. The DF framework utilizes two filters based on positive (input filter) and negative (output filter) verification strategies that can communicate with each other for higher robustness.

This application claims benefit of U.S. Provisional App. No. 63/022,323, filed May 8, 2020, and U.S. Provisional App. No. 63/186,088, filed May 8, 2021 the complete disclosures of both of which are incorporated herein in their entireties by specific reference for all purposes.

### FIELD OF INVENTION

This invention relates to a system and related methods to prevent and protect against adversarial attacks on machine-learning systems.

### SUMMARY OF INVENTION

In various exemplary embodiments, the present invention comprises a dual-filtering (DF) system to provide a robust machine-learning (ML) platform against adversaries. It employs different filtering mechanisms (one at the input and the other at the output/decision end of the learning system) to thwart adversarial attacks. The developed dual-filter software can be used as a wrapper to any existing ML-based decision support system to prevent a wide variety of adversarial evasion attacks. The dual-filtering provides better decisions under manipulated input and contaminated learning systems in which existing heavy-weight trained ML-based decision models are likely to fail.

Machine-learning techniques have recently attained impressive performances on diverse and challenging problems. In spite of their major breakthroughs in solving complex tasks, it has been lately discovered that ML techniques (especially artificial neural networks and data-driven artificial intelligence) are highly vulnerable to deliberately crafted samples (i.e., adversarial examples) either at training or at test time. There are three basic types of adversarial attacks: (1) Poisoning attack: In this attack, the attacker can corrupt training data and create adversarial examples later to work on the model. It happens in training time. (2) Evasion attack: In this attack, testing inputs change in a way that they miss-classify to another random or targeted class. (3) Trojan AI attack: In this attack, the AI model's architecture changes in a way so that it misclassifies the input.

To safeguard ML techniques against malicious adversarial attacks, several countermeasure schemes have been proposed. These countermeasure generally fall within two categories: adversarial defense and adversarial detection. Despite the current progress on increasing robustness of ML techniques against malicious attacks, the majority of existing countermeasures still do not scale well and have low generalization. Adversaries (adversarial samples/input) still pose great threats to ML and artificial intelligence (AI). For example, existing algorithms and directions are not working well, which demands novel schemes and directions.

Existing learning systems (ML/AI-based commercial products/services) do not have any protective shields against adversarial attacks. The present invention comprises trustworthy ML-based techniques, services, and products that intelligently thwart adversarial attacks by using a DF defensive shield. Contrary to prior techniques, the DF framework utilizes two filters based on positive (input filter) and negative (output filter) verification strategies that can communicate with each other for higher robustness. It is a generic technique to be used in any AI/ML-based products, services and frameworks.

### BRIEF DESCRIPTION OF THE DRAWINGS

FIG. 1 shows a diagram of a DF framework in accordance with an exemplary embodiment of the present invention.

FIG. 2 illustrates the processing steps of ensemble input filters in serial fashion. Particularly, for a given input, the individual filter (attack detector) will provide a ticket indicating that the sample is an attack; otherwise, the sample is considered benign and will be fed to the learning system.

FIG. 3 describes a detailed flow diagram of a DF framework indicating implementation steps in training and test phases.

FIG. 4 illustrates another processing flow of a DF framework.

FIG. 5 shows the DF framework interaction with an adaptive learning module.

FIG. 6 shows a process flow for a multi-objective genetic search for filters.

### DETAILED DESCRIPTION OF EXEMPLARY EMBODIMENTS

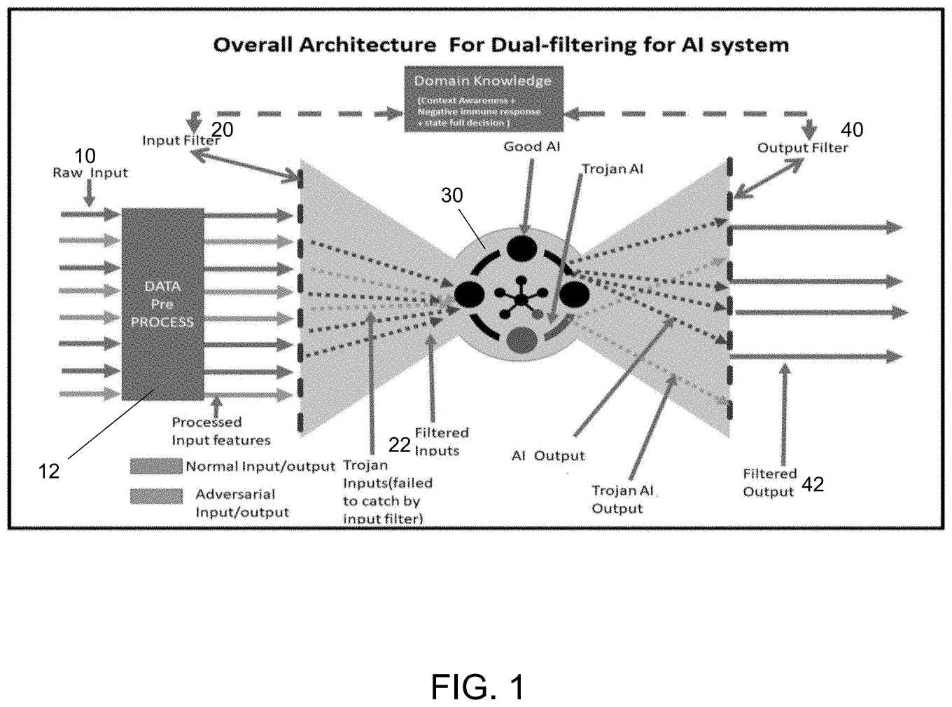

In various exemplary embodiments, the present invention comprises a dual-filtering (DF) (i.e., commutative filtering) strategies at both ends (input and output). This is in contrast to prior art ML-based decision support techniques using only input filters, such as deep neural networks (DNNs),which are trained offline (supervised learning) using large datasets of different types including images/videos and other sensory data. As seen in FIG. 1, the DF system of the present invention employs two filtering mechanisms in any ML/AI framework, i.e., one filtering mechanism at the input stage (before the data sample is fed into the ML model), and a second filtering mechanism at the output stage (before outputting the decision); the first and second filters will hereafter be referred as “input filter” and “output filter.” These two filters can function independently as well as dependently (i.e., communicate with each other using a knowledge base for conformity). A communication channel (for message passing and dialogue) between the input and output filters is designed and developed which encompass context-sensitive, situation-aware strategies, and serve as a stateful mediator for conflict resolution.

Specifically, the input filter's main aim is to filter misleading and out of distribution inputs (e.g., image of animal but not human face in a face recognition system). The output filter's goal is handling larger variations and restricting misclassification rates in order to improve overall accuracy of the system. The proposed dual-filtering strategy can be used both in training and testing phases of ML. For instance, the independent input filter may be used to detect and deter the poising attacks in a supervised ML. Likewise, dual-commutative filters may help addressing adversaries both in supervised and unsupervised ML.

A machine learning framework usually consists of four main modules: feature extraction, feature selection (optional), classification/clustering, and decision. As depicted in FIG. 1, the input filters 20 are placed after pre-processing 12 of data stream/feature selection to feed to core learning model and the output filters 40 are placed after the classification/clustering/raw decision module, respectively. Mainly, various negative selection algorithms (for generating negative detectors) are utilized to attain robust output/decision space. Different adaptive (positive) pre-processing or detection methods may be used in the input filtering scheme.

As can been seen in FIG. 1, the raw input sample 10 is first pre-processed 12 and then fed to the input filter or filter set 20 to determine if the received feature/sample is benign or attack and reject or pass 22 accordingly. The outcome (i.e., raw decision) by the artificial-intelligence or machine-learning (AI/ML) model or system 30 is given to the output filter or filter set 40 for further scrutiny. The output filter uses context-information and/or communicates with the input filter to make the correct final decision for output 42.

In several embodiments, the defensive measures of the present invention for the AI/ML model have the following tasks. The primary purpose of input filters (placed before the AI/ML model) is to prevent adversarial input data in such a way that can differentiate data manipulation from the trained data. It will examine the input by deploying an application-specific filter sequence. A set of filter sequences are selected (from a given library of filters) using an efficient search and optimization algorithm, called multi-objective genetic algorithm (MOGA) 600. The MOGA can find a sequence of filters (where each filter can detect adversarial traits/noises) satisfying constrains and three objectives: detection of the maximum number of attacks with higher accuracy (above a specific threshold), with minimum processing time, and shorter sequence of ensemble filters. By utilizing the Pareto-set from MOGA runs, and picking a filter sequence dynamically at different times, the present invention makes filter selections unpredictable and uses an active learning approach in order to protect the AI/ML from adaptive attacks.

The output filter(s) 40 (after the AI/ML model) employs several class-specific latent space-based transformation for outlier detection. After the ML model provides an output class label, it is then verified if the output falls in that class's latent space or not. The present invention makes an ensemble of different outlier detection methods and sequence dynamically and also retrains the outlier methods runtime.

The adversarial defense system of the present inventions meets the following objectives:

(1) It works against a diverse set of attack types, including, but not limited to, gradient or no-gradient, white-box or black-box, targeted or not targeted, adaptive attacks.

(2) It does not reduce the accuracy of ML models. The model accuracy does not get effected after deploying the defense technique of the present invention.

(3) It identifies threats faster. If a defense system takes sizeable computational time and resources, it will lose practicability. For example, if the defense is employed in an autonomous car sensor, the input responses need to be evaluated first. Otherwise, an accident can happen.

(4) It does not modify the ML architecture. It works for both the white-box and black-box models. A trained ML's architectural information is usually black-box. The present invention's framework complies with that.

(5) It is adaptive in nature and dynamic to prevent adaptive attacks.

(6) It does not need to update if the ML changes (e.g., Resnet to VGG or ANN to RNN), it is cross-domain (image, audio, text) supported.

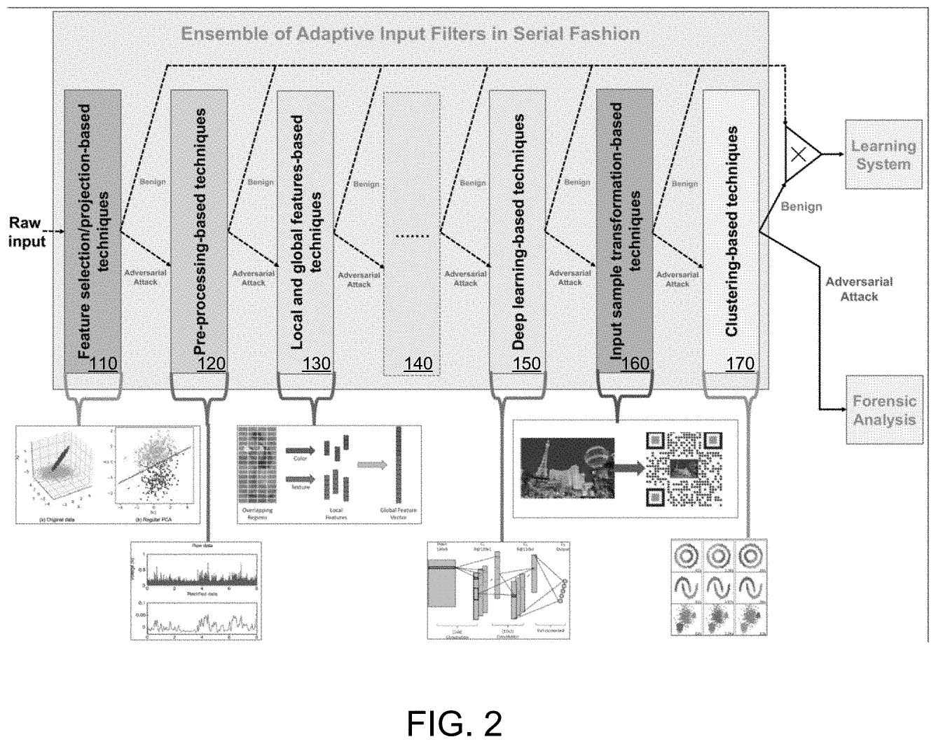

Examples of input filter sequences are shown in FIG. 2. These include, but are not limited to, feature selection/projections-based techniques 110, pre-processing-based techniques 120, local and global features-based techniques 130, entropy-based techniques 140, deep learning-based techniques 150, input sample transformation-based techniques 160, and clustering-based techniques 170.

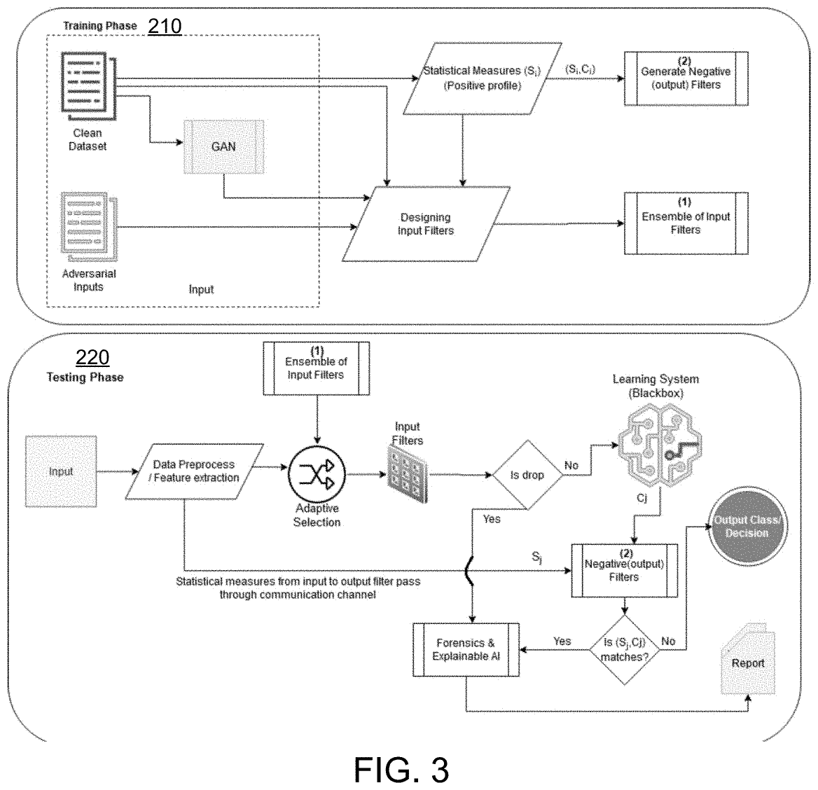

The dual-filtering strategy can be used both in training 210 and testing 220 phases of ML technologies, as seen in FIG. 3. Accordingly, the dual-filtering method can successfully handle the deliberately adversarial attacks or crafted samples (which can efficiently subvert ML techniques outcomes) either at training or at test time. The DF technique is applicable to diverse applications such as malware/intrusion detection, image classification, object detection, speech recognition, face recognition in-the-wild, self-driving vehicles, and similar applications. Current and future technologies and products based on machine learning and data-driven artificial intelligence can exploit the dual-filtering techniques (e.g., a search engine can wrap its search algorithm with dual commutative filtering scheme to attain human-level or higher accuracies). Similarly, any commercial product that is using advanced machine/deep/reinforcement learning can be benefited from the proposed DF technique. For instance, the Google image search engine can use the DF protective technique to retrieve the optimal image searches even under adversarial queries/attacks.

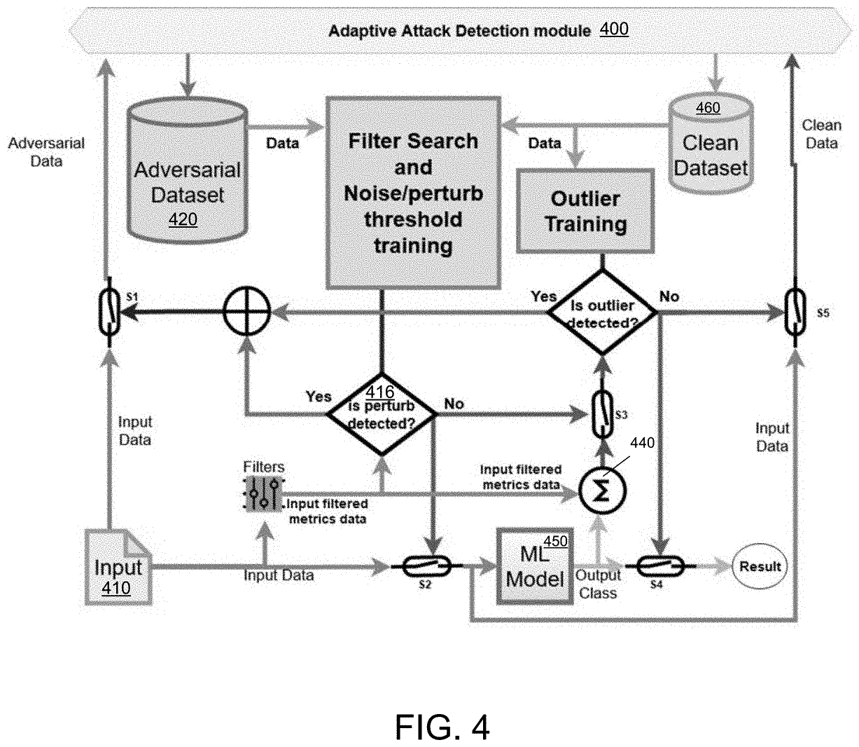

FIG. 4 illustrates an exemplary framework of the present invention. It applies different filters to detect adversarial input noise. The system needs to know which filter is needed and the difference between the clean and adversarial noise threshold. That is why the system first uses the information from the ML model to determine whether the input is an outlier for the class label the ML model is classified. If it is an outlier, it is sent to the adversarial dataset. If not, it is sent to the clean dataset and updates the outlier methods decision boundary and used to determine the required filters and the noise thresholds. Before updating and retraining the output and input learning model, the system inspects the data for adaptive attack patterns in the adaptive attack detection module 400.

The basic workflows shown in FIG. 2 are as follows:

1. Input 410 is sent for filters to extract different metrics (e.g., SNR, Histogram, and the like). There is a dynamic selection of the filter set from the filter library.

2. The extracted filter metrics value is checked for perturb 416; if it is above a certain threshold, switch S1 will open. otherwise switches S2 and S3 will open.

3. If S1 opens: Input is sent to adversarial dataset 420 and the process will terminate. The adversarial dataset will retrain the filter sequence search for noise detection and change the threshold value.

4. If S3 and S2 open: When S3 opens, extracted filter metrics value will be sent to outlier detection system 440. When S2 opens, input data will be sent to ML model 450 and switch S5.

5. The ML model 450 delivers the output class to switch S4 and outlier detection system 440.

6. The outlier detection system 440 randomly picks one outlier detection method. If it detected as outlier witch S1 will open, otherwise S4 and S5 will open.

7. If S1 opens: Input will be sent to adversarial dataset 420 and the process will terminate. The adversarial dataset will retrain the filter sequence search for noise detection and change the threshold value.

8. If S4 and S5 open: S4 will provide the final output class, and S5 will send the input to the clean dataset 460 which will trigger the retrain of outlier methods and change the outlier decision boundary.

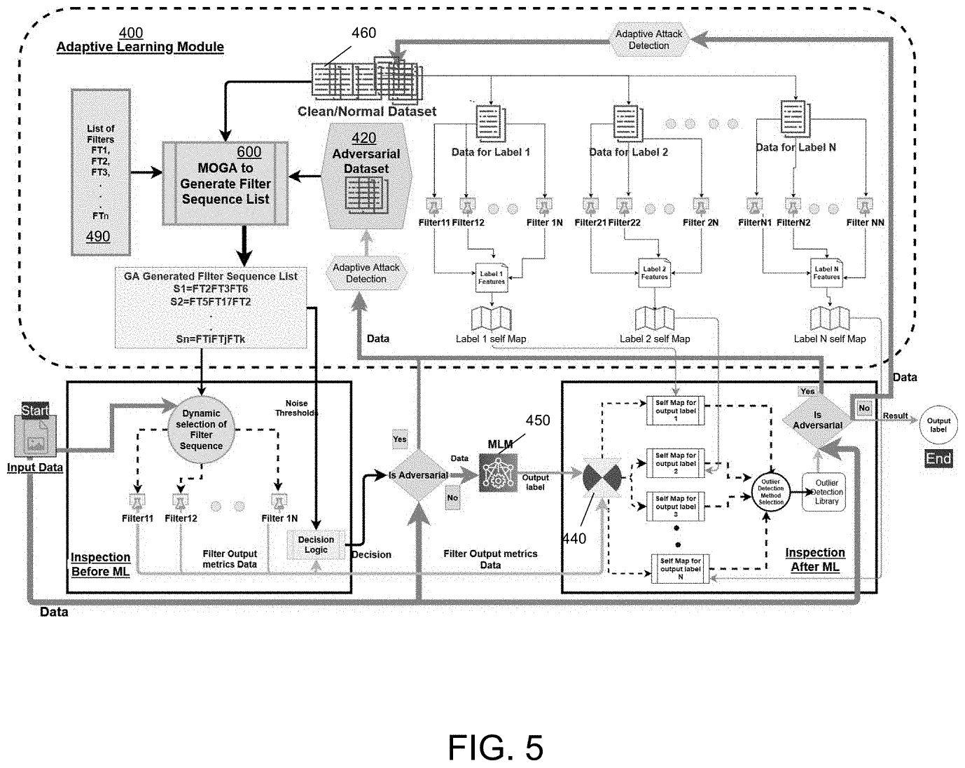

FIG. 5 shows an exemplary embodiment of the dual inspection strategy. The inspection before and after the ML module 450 are independent and can be deployed as a plugin. As in active learning, when the clean dataset 460 has some data, it will train the outlier detection techniques, and the “inspection after ML” module will start to work. After the outlier finds some adversarial examples, the adversarial dataset receives some adversarial data. When the adversarial dataset has sufficient data, the multi-objective genetic algorithm (MOGA) 600 starts the genetic search for filter sequences that are effective against the adversarial noises and the differentiating noise thresholds for these sequences. As time progresses, the MOGA will detect more adversarial samples, and the knowledge of the outlier detection technique will transfer to noise detection techniques. In this process, the ML model 450 has to process fewer adversarial examples. The system selects different filter sequences for each input and different outlier detection methods for each input in order to make the defense dynamic. After each input (or after a specific amount of input), outlier methods will retrain, and the system will update the outlier detection decision boundary. Similarly, the MOGA 600 will update the filters library 490 subsequently. As a result both the outlier and filter-based defense techniques will keep themselves updated as time progresses. The system stores the data and inspects for an adaptive attack pattern before update the filters and outlier detection methods.

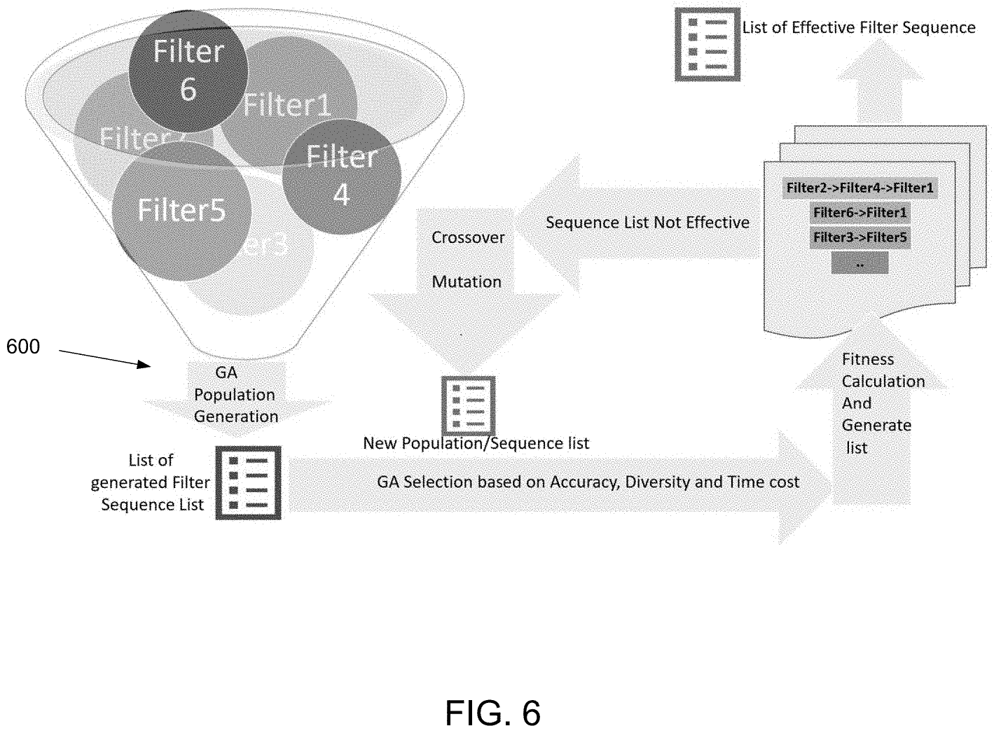

As seen in FIG. 6, the present invention applies multiple filter sequences and does not use the same sequence of filter for every input. A filter sequence can be any length. A search for optimal set of sequences requires significant computational time if an exhaustive search considering multiple objectives is performed. The system thus employs a MOGA 600 to search for the optimal set of sequences as pareto-front solutions. For search filters, the system considers different factors besides their accuracy. Based on the objective, the filters need to be fast. That is why the order of the filters is important: different orders of filters require different amounts of processing times. It is preferable to have filter order solutions be time efficient. If there are N number of filters, then total possible number of sequences will be the search space. If time efficiency is not considered, then filters do not need to be order in a combination or sequence (for different order, the sequence accuracy remains static but the time efficiency changes). Search space is optimized by limiting the minimum sequence length and maximum sequence length.

Other advantages and uses include:
Use of commutative dual filtering technique in any AI/ML—based utility applications.
Regularly replacing negative filters make the filters adaptive and unpredictable to compromise.
Use of negative filtering will prevent Trojan AI to change decisions resulting in robust AI/ML systems.
Easy to incorporate in existing and future ML systems will increase adoption and deplorability.
Enhanced performance/accuracy and robustness of ML products and online services will increase in diverse applications.
Improved defense will result in building trustworthy AI/ML for decision support and significantly increase the quality of experience of users.
Dynamic selection of filter set sequence which will make it harder to formulate adaptive attack based on known filter knowledge.
Dynamic selection of outlier detection method, it will make the adaptive attack to consider all outlier detection method when developing attack input that will make generating input computationally expensive.
Defense is always learning which will continue changing the filter sequences and decision boundary of outlier detection models. It will make an adaptive attack difficult to search decision boundary.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system to defend against adversarial attacks on an artificial-intelligence or machine-learning (AI/ML) system, comprising:
a dual-filtering mechanism, comprising a first filter set and a second filter set;
wherein the first filter set is an input filter set, and the second filter set is an output or decision filter set;
wherein the input filter set receives a plurality of processed input data streams for input to an artificial-intelligence or machine-learning (AI/ML) model, and rejects processed input data streams that do not meet problem-defined clean or normal input criteria; and
further wherein the output filter receives a plurality of raw decision outputs from the AI/ML model for transmission to a final decision module, and rejects raw outputs that do not problem-defined decision criteria.

2. The system of claim 1, wherein the first filter set and second filter operate set independently.

3. The system of claim 1, wherein the first filter set and second filter set operate commutatively.

4. The system of claim 1, further comprising a data pre-processor, wherein the data preprocessor receives a plurality of raw input data streams and sends the plurality of processed input data streams to the input filter.

5. The system of claim 1, further wherein said AI/ML system comprises a feature extraction module and a classification/clustering module, said input filter set passes unrejected processed input data streams to the feature extraction module, and said classification/clustering module sends the plurality of raw decision outputs to the output filter set.

6. The system of claim 1, wherein the input filter set applies positive verification strategies.

7. The system of claim 1, wherein the output filter set applies negative verification strategies.

8. The system of claim 7, wherein the output filter set is generated in complementary space derived from positive features extracted out of clean input data samples.

9. The system of claim 7, wherein the output filter set blocks wrong or incorrect decisions of the AI/ML model.

10. The system of claim 1, further comprising an adaptive learning module, configured to receive rejected processed input data streams from the input filter and rejected raw decision outputs from the output filter, and add said data streams to an adversarial dataset.

11. The system of claim 1, wherein said adaptive learning module further comprises a multi-objective genetic algorithm configured to select a set of filter sequences for the input filter.

12. The system of claim 11, wherein set of filter sequences is optimized for speed.

13. The system of claim 11, wherein the set of filter sequences comprises two or more of the following: features election/projections-based techniques, pre-processing-based techniques, local and global features-based techniques, deep learning-based techniques, entropy-based techniques, input sample transformation-based techniques, and clustering-based techniques.

14. The system of claim 10, wherein the input filter set is periodically modified by the adaptive learning module.

15. The system of claim 10, wherein the output filter set is periodically modified by the adaptive learning module.

16. The system of claim 1, wherein the dual-filtering mechanism and framework are deployed as a library configured to be added to as an extension to any machine-learning model.

17. The system of claim 1, wherein the dual-filtering mechanism and framework does not need to know or modify any machine-learning model layer.

18. The system of claim 1, wherein said system forms a closed loop via signaling and message-passing mechanisms.
